(19) United States
(12) Patent Application Publication
(10) Pub. No.: US 2022/0174076 A1
(43) Pub. Date: Jun. 2, 2022

(54) METHODS AND SYSTEMS FOR RECOGNIZING VIDEO STREAM HIJACKING ON EDGE DEVICES

(71) Applicant: Microsoft Technology Licensing, LLC, Redmond, WA (US)

(72) Inventors: Jagadeshwar Reddy NOMULA, Sunnyvale, CA (US); Thomas Lawrence NEUMARK, Point of Rocks, MD (US); Michael Allen TIBBETTS, Broomfield, CO (US)

(21) Appl. No.: 17/107,025

(22) Filed: Nov. 30, 2020

(51) Int. Cl. H04L 29/06; G06K 9/00; G06N 3/08; G06K 9/62

(52) U.S. Cl. CPC H04L 63/1416; G06K 9/00718; G06K 2009/00738; H04L 63/10; G06K 9/628; G06N 3/08

(57) ABSTRACT

The devices and methods may include an edge device including a tampering detection firewall. The tampering detection firewall may receive video streams from cameras in communication with the edge device. The tampering detection firewall may also receive device information from the cameras and/or a plurality of devices in communication with the edge device. The tampering detection firewall may have a set of rules to identify whether different types of tampering occurred on the video streams or the device information. The tampering detection firewall may apply one or more of the rules to classify whether any tampering occurred. The tampering detection firewall may send an alert in response to determining that tampering occurred on the video streams or the device information.

### BACKGROUND

Video analytics systems may use artificial intelligence (AI) powered video analytics software to analyze videos and track stealing and/or monitor movements. The video analytics systems may alert organizations of anomalies detected in the analyzed videos and/or any issues that may need attention in the analyzed videos. As the reliance on video analytics increases by organizations, it becomes important to protect the video analytics systems from attackers that may trick and/or hijack the video analytics systems.

### BRIEF SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

One example implementation relates to a method performed by an edge device. The method may include receiving a video stream. The method may include applying, at the edge device, at least one rule of a plurality of rules to the video stream to determine whether tampering occurred to the video stream, wherein each rule of the plurality of rules includes a corresponding classification model running a machine learning algorithm that analyzes the video stream and outputs a tampering classification for the video stream. The method may include determining the tampering classification for the video stream that identifies whether any tampering occurred to the video stream in response to applying the at least one rule to the video stream. The method may include sending an alert in response to the tampering classification indicating that tampering occurred to the video stream. The method may include processing the video stream in response to the tampering classification indicating that tampering occurred to the video stream.

Another example implementation relates to an edge device. The edge device one or more processors; memory in electronic communication with the one or more processors; and instructions stored in the memory, the instructions executable by the one or more processors to: receive a video stream from a camera in communication with the edge device; apply at least one rule of a plurality of rules to the video stream to determine whether tampering occurred to the video stream, wherein each rule of the plurality of rules includes a corresponding classification model running a machine learning algorithm that analyzes the video stream and outputs a tampering classification for the video stream; determine the tampering classification for the video stream that identifies whether any tampering occurred to the video stream in response to applying the at least one rule to the video stream; send an alert in response to the tampering classification indicating that tampering occurred to the video stream; and process the video stream in response to the tampering classification indicating that tampering occurred to the video stream.

Another example implementation relates to a method. The method may include receiving, at an edge device, device information from a plurality of devices in communication with the edge device. The method may include applying, at the edge device, at least one rule of a plurality of rules to the device information to determine whether tampering occurred to the device information, wherein each rule of the plurality of rules includes a corresponding classification model running a machine learning algorithm that analyzes the device information and outputs a tampering classification for the device information. The method may include determining the tampering classification for the device information that identifies whether any tampering occurred to the device information in response to applying the at least one rule to the device information. The method may include sending an alert in response to the tampering classification indicating that tampering occurred to the device information.

Additional features and advantages will be set forth in the description which follows, and in part will be obvious from the description, or may be learned by the practice of the teachings herein. Features and advantages of the disclosure may be realized and obtained by means of the instruments and combinations particularly pointed out in the appended claims. Features of the present disclosure will become more fully apparent from the following description and appended claims, or may be learned by the practice of the disclosure as set forth hereinafter.

### BRIEF DESCRIPTION OF THE DRAWINGS

In order to describe the manner in which the above-recited and other features of the disclosure can be obtained, a more particular description will be rendered by reference to specific implementations thereof which are illustrated in the appended drawings. For better understanding, the like elements have been designated by like reference numbers throughout the various accompanying figures. While some of the drawings may be schematic or exaggerated representations of concepts, at least some of the drawings may be drawn to scale. Understanding that the drawings depict some example implementations, the implementations will be described and explained with additional specificity and detail through the use of the accompanying drawings in which:

FIG. 1 illustrates an example system in accordance with implementations of the present disclosure.

FIG. 2 illustrates an example tampering detection firewall for use with implementations of the present disclosure.

FIG. 3 illustrates an example method for identifying whether tampering occurred in accordance with implementations of the present disclosure.

FIG. 4 illustrates certain components that may be included within a computer system.

### DETAILED DESCRIPTION

This disclosure generally relates to edge device security. One example use case for edge devices is artificial intelligence (AI) powered video analytics, analyzing the images in the videos. The images in the video may be analyzed to perform one or more actions in response to the analysis. Examples of video analytics may include, but are not limited to, video surveillance, monitoring activities, monitoring movements, and/or compliance with rules or regulations. Video analytics may generate an alert to notify users of a system when an issue is detected. For example, if a theft of an object occurred, video analytics may be used to alert users that a theft occurred, identify when the theft occurred, and/or identify potential suspects. Another example may include regulations limiting a number of customers allowed in a shop at the same time and video analytics may be used to alert users of non-compliance with the regulations.

As use of AI powered video analytics increases, it becomes important to protect the systems from attackers who can trick and/or hijack the video analytics systems. One example mechanism that attackers use to trick the video analytics system includes attackers redirecting the RTSP stream of video streams to play a tape loop from another day by hijacking or taking control of the network. Another example mechanism that attackers use to trick the video analytics system includes attackers using Deep Learning techniques to fake a video stream and replace the original video stream. The attackers, for instance, may physically point the camera to another camera which can show an existing video recording. Another example mechanism that attackers use to trick to the video analytics system includes physically simulating movements to generate false alerts to divert the attention. For instance, attackers may act in a suspicious manner in one location to trick the video analytics system to raise a false alarm diverting the focus of the users. As such, many possible breaches exist for the video analytics system.

The present disclosure provides devices and methods for protecting an edge device from attack or tampering. The edge devices may run a video analytics system analyzing one or more video streams received from cameras in communication with the edge device. A tampering detection firewall may analyze the video streams and determine whether any tampering is occurring to the video streams. Tampering may include, for example, changing network level settings and pointing to a different video recording, such as, a previously recorded video. Tampering may also include using deep fake technology to simulate a video so that suspicious items in the video are not readily identifiable. In addition, tampering may include directing or pointing a camera to another location.

The edge devices may generate alerts in response to identifying tampering so that one or more actions may be taken in response to any tampering. The edge devices may analyze the video streams using the video analytics system in response to identifying that no tampering occurred on the video streams. The present disclosure may be used to ensure that the videos streams are authentic without tampering. As such, the present disclosure includes several practical applications that provide benefits and/or solve problems associated with providing edge device security.

The edge device may have a tampering detection firewall that receives the video streams and/or any device information from cameras and/or devices in communication with the edge device. The tampering detection firewall may also receive any additional information about the video streams. The tampering detection firewall may have a set of rules to identify whether different types of tampering occurred to the video streams and/or the device information and may apply the set of rules to classify whether any tampering occurred on the video streams and/or the device information. The tampering detection firewall may run machine learning algorithms with different classification models that takes the features of the video stream as input and outputs a classification of the video as tampered or not tampered.

The tampering detection firewall may send an alert indicating that video tampering occurred. The alert may be received by users of the video analytic systems to perform one or more actions in response to the video tampering. Example actions may include, but are not limited to, sending an email message, sending a text message, sending a video alert, sending an audible alert, triggering an alarm, and/or calling law enforcement individuals (e.g., calling 911).

As such, the present disclosure may perform computing at the edge to generate alerts when tampering of video streams and/or device information is detected. In addition, the present disclosure may be used to ensure that the videos streams analyzed by the video analytics systems are authentic without tampering.

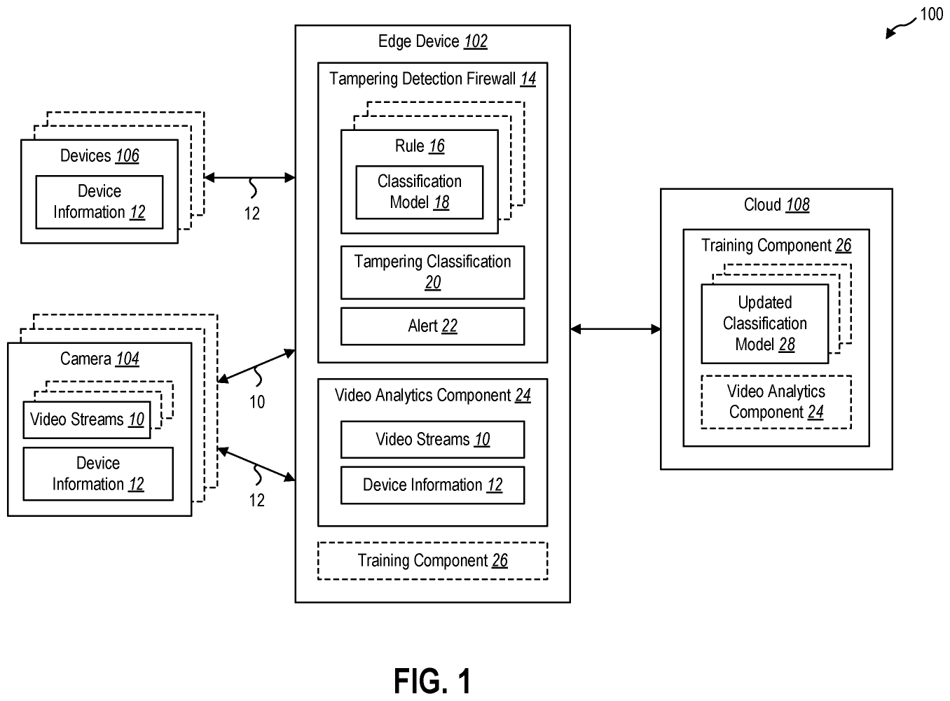

Referring now to FIG. 1, illustrated is an example system 100 for use with providing edge device security. System 100 may include a plurality of edge devices 102 (up to n, where n is an integer) in communication with the cloud 108 via a network. The network may include one or multiple networks that use one or more communication platforms or technologies for transmitting data. For example, the network may include the internet or other data link that enables transport of electronic data between respective devices of the system 100.

Edge devices may include any computer device that is able to work in an offline context and/or is remote from the cloud 108. For example, edge devices 102 may include mobile devices, desktop computers, server devices, or other types of computing devices. Each edge device 102 may have a plurality of cameras 104 and/or other devices 106 in communication with the edge device 102. In an implementation, the other devices 106 include internet of things (IoT) devices. IoT devices may include any device with a sensor and/or an actuator.

The cameras 104 and/or the devices 106 may send device information 12 to the edge device 102. The device information 12 may include, but is not limited to, sensor information and/or device metadata. For example, device metadata may include a heartbeat of the device 106 and/or camera 104 indicating whether the device 106 and/or the camera 104 is connected to the edge device 102 or the cloud 108. Example sensor data may include identifying motion nearby the device 106 and/or camera 104, identifying objects nearby the device 106 and/or camera 104, and/or a reading taken by the device 106 (e.g., temperature or weight).

In addition, the cameras 104 may capture video streams 10 and may send the video streams 10 to the edge device 102. The edge device 102 may have a tampering detection firewall 14 that receives the video streams 10 and/or any device information 12. The tampering detection firewall 14 may determine whether any tampering occurred with the video streams 10 and/or the device information 12. Tampering may include, for example, modifying device information 12, modifying the video streams 10, and/or modifying network information to trick the systems and processes on the edge device 102 and/or the cloud 108 into thinking the video streams 10 and/or the device information 12 are genuine.

An example of tampering with video streams may include, for example, changing network level settings and point to a different video recording, such as, a previously recorded video. Another example of tampering with video streams may also include using deep fake technology to simulate a video so that suspicious items in the video are not readily identifiable. Another example of tampering with video streams may include directing or pointing a camera to another location.

An example of tampering with the devices 106 and/or the cameras 104 may include an individual moving the direction of the camera 104 and/or the devices 106. Another example may include removing power for the camera 104 and/or the devices 106. Another example may include using a reflection mirror to point the camera 104 towards another location or point the camera 104 towards another object.

The tampering detection firewall 14 may have a set of rules 16 (up to m, where m is an integer) to identify whether different types of tampering occurred. The tampering detection firewall 14 applies one or more of the rules 16 to determine whether any tampering occurred on the video streams 10 and/or the device information 12. Each rule 16 may focus on one or more features of tampering. As such, one rule 16 may focus on a single feature of tampering, while another rule 16 may focus on a combination of features of tampering. One example rule may identify whether the network route for a video stream is changed or is modified. Another example rule may identify whether a deep fake video is shown. Another example rule may identify whether a video stream of a previous day or past month is shown. Another example rule may identify whether an individual moved the direction of the camera 104 or whether a reflection mirror was used to point the camera 104 towards another location or point the camera 104 towards another object. Another example rule may include identifying whether power was removed for the camera 104.

Each rule 16 may run a different classification model 18 to classify whether tampering occurred on the video streams 10 and/or the device information 12. The tampering detection firewall 14 may run different machine learning algorithms for each rule 16 to determine whether tampering occurred on the video streams 10 and/or the device information 12.

In some implementations, one or more rules 16 may use a different deep learning neural networks as the classification models 18 that receives the features of the video streams 10 and/or device the information 12 as input and outputs a tampering classification 20 of the video streams 10 and/or the device information 12 as tampered or not tampered. The deep neural network for instance may have a series of convolution layers, a feed-forward layer, and a final sigmoid layer for the tampering classification 20.

In some implementations, one or more rules 16 may use deep reinforcement models as the classification models 18 that receives the features of the video streams 10 and/or device the information 12 as input and outputs a tampering classification 20 of the video streams 10 and/or the device information 12 as tampered or not tampered. The classification model 18 of the deep reinforcement model may generate messages or alerts indicating that tampering occurred with the video streams 10 and/or the device information 12. The messages or alerts may be sent to a user for verification. The user may provide feedback indicating that the classification was correct or incorrect. The user feedback may be used as a reward for training the classification model 18 and improving the classification model 18. The datasets for the classification model 18 may be imbalanced (e.g., one video tampering may occur out of ten thousand video deployments). As such, the reward for the user feedback indicating that tampering occurred may be increased so that the classification model 18 may learn the reward mechanism faster for video where tampering occurred as compared to a video where no tampering occurred.

In some implementations, one or more rules 16 may use a combination of Convolution Neural Networks and Bi-Directional Neural Networks as the classification models 18 that receives the features of the video streams 10 and/or device the information 12 as input and outputs a tampering classification 20 of the video streams 10 and/or the device information 12 as tampered or not tampered.

In some implementation, one or more rules 16 may use simplistic Logistic Regression as the classification models 18 that receives the features of the video streams 10 and/or device the information 12 as input and outputs a tampering classification 20 of the video streams 10 and/or the device information 12 as tampered or not tampered.

Different combination of machine learning may be used for the classification models 18. For example, a logistic regression model may be used for an initial classification of the video streams 10 and/or the device information 12 while a deep neural network may be used to perform a fine grain analysis of the features of the video streams 10.

The tampering detection firewall 14 may run all the rules 16. In addition, the tampering detection firewall 14 may select a subset of the rules 16 to run to determine whether any tampering occurred. The tampering detection firewall 14 may select the subset of rules 16 based on one or more conditions. Conditions may include, but are not limited to, a business type, an environment being monitored, default settings, user selected settings, custom models, similar customers, compute costs of the edge device 102, and/or energy consumption of the edge device 102. An example condition may include different rules 16 having different compute costs and/or energy consumption of the edge device 102. For example, one rule 16 may have a high computation intensive classification model 18 (e.g., requires several cores to perform) as compared to a different rule 16. The tampering detection firewall 14 may run a subset of rules 16 with lower compute costs first, and if one or more tampering classifications 20 indicate that tampering occurred on the video streams 10 and/or the device information 12, the tampering detection firewall 14 may not run the remaining rules 16. However, if the one or more tampering classifications 20 indicate that that no tampering occurred on the video streams 10 and/or the device information 12, the tampering detection firewall 14 may decide to run the remaining rules 16 that have a higher compute costs relative to the subset of rules 16 previously run by the tampering detection firewall 14 with a lower compute cost.

If the tampering classification 20 identifies that no tampering occurred to the device information 12 and/or the video streams 10, the edge device 102 may perform additional processing on the video streams 10. Additional processing may include, but is not limited to, archiving the video streams 10, performing video analytics on the video streams 10, and/or merging the video streams 10 with other sensors. For example, the tampering detection firewall 14 may send the video streams 10 to a video analytics component 24. The video analytics component 24 may perform video analytics by analyzing the images in the video streams 10 and performing one or more actions in response to the analysis. Examples of video analytics may include, but is not limited to, video surveillance, monitoring activities, monitoring movements, and/or monitoring compliance with rules or regulations. In an implementation, the video analytics component 24 may be remote from the edge device 102 on the cloud 108. As such, the tampering detection firewall 14 may send the video streams 10 and/or the device information 12 to the cloud 108 for analysis.

If the tampering classification 20 identifies that tampering occurred to the device information 12 and/or the video streams 10, the tampering detection firewall 14 may generate an alert 22 notifying users of system 100 that the tampering occurred. The alert 22 may include, for example, automatically sending a message (e.g., sending an e-mail or a SMS message to the users), automatically placing a call (e.g., automatically calling the users, security, or law enforcement individuals), and/or sounding an alarm. The users may take one or more actions in response to receiving the alert 22 indicating that tampering occurred.

In addition, the tampering detection firewall 14 may prevent the video streams 10 and/or the device information 12 from use by the video analytics component 24. As such, the tampering detection firewall 14 may filter out any suspicious video streams 10 and/or the device information 12 so that the video analytic component 24 uses authentic or genuine video streams 10 and/or the device information 12 in performing the video analytics.

The tampering detection firewall 14 monitoring process on the video streams 10 and/or the device information 12 may be scheduled to run at predetermined times. For example, the monitoring process may run every ten minutes. Depending on the situation and/or the environment, the monitoring process may run every five minutes or at smaller increments of time (e.g., every minute).

In some implementations, the tampering detection firewall may send the video streams 10 and/or the device information 12 for retraining of the classification models 18 in response to the tampering classification 20 identifying that tampering occurred to the device information 12 and/or the video streams 10. Each edge device 102 sends information back to the cloud 108. Information may include, but is not limited to, video streams 10, device information 12, network latency information, ping trace routes information, and/or runtime information. The cloud 108 may have a training component 26 that may use the information to train an updated classification model 28. The updated classification model 28 may be a new classification model or an augmented classification model. By aggregating the information from different edge devices 102, the training component 26 may build a more robust classification model.

The features of the video streams 10 and/or the device information 12 may be sent to the cloud 108 to use in the retraining of the classification models 18. Feature selection may be applied to ensure that the features sent to the cloud are features that will enhance the classification models 18 or augment the classification models 18. For example, the edge devices 102 may send video frames with significant information and/or important information, such as, cars, objects, individuals, animals, etc. to the cloud 108 to conserve the network bandwidth used for transmitting the video frames. In an implementation, a heuristic may be used for sending the video frames to the cloud 108 for retraining. An example heuristic may include sending 10 prior video frames and sending 10 later video frames for use in identifying more than a configurable threshold number of objects in the previous set of frames relative to the current set of frames. In another implementation, outlier detection techniques may be used to send the video frames selectively to the cloud 108. One example of an outlier detection algorithm may include leveraging clustering algorithms on the image frame vectors. The image frame vectors may be generated using g transfer learning on top of a Residual Network (ResNet) model. Clusters may be built on the image frames, over a sliding window of session time. Any images which do not belong to existing clusters may be uploaded to the cloud 108, with an assumption that this image frame contains information that was not captured in the previous frames. In yet another implementation, a straightforward machine learning model using techniques, such as, Logistic Regression or a Tree based classifier, may be used for identifying if the data sample has any fraudulent activity or not at the edge device 102. Individual frames may be updated to the cloud 108 selectively based on the result of the machine learning model. In addition, the edge devices 102 may send trace route information for the video streams 10 to the cloud 108. The edge device 102 may also send sensor information or other device information 12 to the cloud 108. As such, the edge device 102 may send a variety of features that the training component 26 may use for training and/or retraining of the different classification models 18.

The cloud 108 may deploy or send the updated classification models 28 to the edge devices 102. The updated classification models 28 may replace existing classification models 18 on the edge device 102. In addition, the updated classification models 28 may be used as a new classification model 18 with a new rule 16 on the edge device 102. As such, adaptive training strategies may ensure that the classification models 18 are continuously trained and/or updated using the features from the captured video. In implementations, the training component 26 may be located on the edge device 102.

The cloud 108 may also learn from other deployments (for example, from other customer systems) within the system 100 and may train the classification models 18 using data received from the other deployments. An example use case may include a tampering detection firewall 14 operating on an edge device 102 of Customer A identifies tampering of video streams 10 at Bank 1, while a different tampering detection firewall 14 operating on an edge device 102 of Customer B identifies tampering of video streams 10 at Bank 2. The cloud 108 may receive the information from the different customers (Customer A, Customer B) and may use the information to train an updated classification model 28. The cloud 108 and may send the updated classification models 28 to the edge devices 102 of both Customer A and Customer B.

In some implementations, a verification may occur to ensure that the updated classification models 28 sent to the edge devices 102 are an improvement of the classification model 18 preexisting on the edge device 102 to ensure that the quality of the classification models 18 are maintained or improved.

Each of the components of the edge device 102 may be in communication with each other using any suitable communication technologies. In addition, while the components of the edge device 102 are shown to be separate, any of the components or subcomponents may be combined into fewer components, such as into a single component, or divided into more components as may serve a particular implementation. Moreover, the components of the edge device 102 may include hardware, software, or both. For example, the components of the edge device 102 may include one or more instructions stored on a computer-readable storage medium and executable by processors of one or more computing devices. When executed by the one or more processors, the computer-executable instructions of one or more computing devices can perform one or more methods described herein. Alternatively, the components of the edge device 102 may include hardware, such as a special purpose processing device to perform a certain function or group of functions. Additionally, or alternatively, the components of the edge device 102 may include a combination of computer-executable instructions and hardware.

As such, system 100 may be used to perform computing at the edge to identify any edge device 102 tampering situation. The tampering detection firewall 14 may identify whether any tampering occurred to sensor data received by the edge device 102 from the one or more devices 106 in communication with the edge device 102 and/or whether any tampering occurred to the devices 106 or the cameras 104. One example of devices 106 in communication with the edge devices 102 may include self-driving cars. System 100 may be used to identify whether any tampering occurred with the sensor data and/or video streams 10 received at the edge devices 102 from the self-driving cars. As such, system 100 may be used to identify whether any hijacking occurred to the self-driving cars.

In addition, the tampering detection firewall 14 may identify whether any tampering occurred with the video streams 10 received at the edge device 102 from one or more cameras 104 in communication with the edge device 102. By identifying any tampering, security may be improved at the edge device 102 by ensuring that the information received by the edge device 102 is accurate and/or authentic.

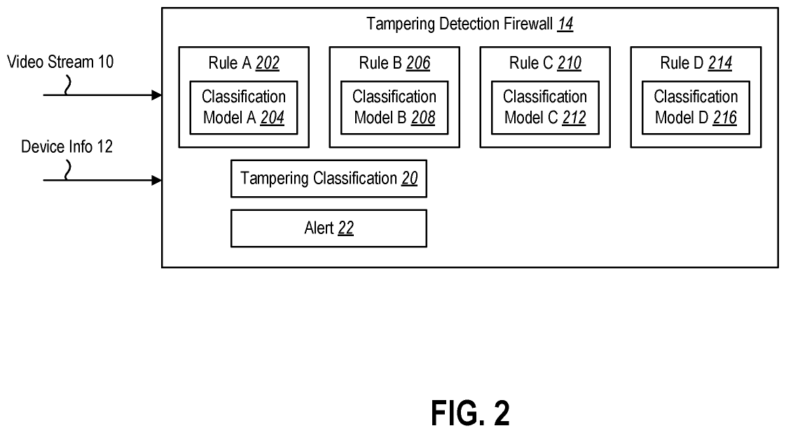

Referring now to FIG. 2, illustrated is an example tampering detection firewall 14 that may be used with an edge device 102 (FIG. 1) in system 100 (FIG. 1) to analyze features of the video streams 10 received at the edge device 102 and determine whether any tampering occurred to the video streams 10. Features of the video streams 10 may include, but are not limited to, trace routes of the video streams 10, latency of the ping route to the video streams 10, frames in the video, and/or a deep fake video.

Tampering may include, for example, modifying the device information 12 of the cameras 104, modifying network information, modifying network settings, and/or modifying the video streams 10. An example of tampering with video streams may include changing network level settings and point to a different video recording, such as, a previously recorded video. Another example of tampering with video streams may also include using deep fake technology to simulate a video so that suspicious items in the video are not readily identifiable. Another example of tampering with video streams may also include directing or pointing a camera to another location. The tampering detection firewall 14 may generate alerts 22 in response to identifying tampering so that one or more actions may be taken in response to any tampering occurring on the video streams 10.

In the illustrated example, the tampering detection firewall 14 may use different rules (Rule A 202, Rule B 206, Rule C 210, Rule D 214) to identify whether tampering occurred to the video streams 10. Each rule may focus on one or more features of tampering. As such, a rule may focus on a single feature of tampering or a combination of features of tampering.

Rule A 202 may focus on trace routes for the video streams 10. Rule A 202 may have a classification model A 204 that receives the features from different time samples from the video streams 10 and outputs a tampering classification 20 for the video streams 10.

For example, the classification model A 204 is a simplistic Logistic Regression model that receives the features from different time samples from the video streams 10 as input and determines whether the trace route for the video streams 10 changed. If the trace route to the RTSB video stream host changed, the classification model A 204 outputs a tampering classification 20 that tampering occurred on the video streams 10. If the trace route to the RTSB video stream host remained the same, the classification model A 204 outputs a tampering classification 20 that no tampering occurred on the video streams 10.

Rule B 206 may focus on a sliding window of a configurable number of frames for the video streams 10. Samples of the configurable number of frames may be taken at different times from different video streams 10. Rule B 206 may have a classification model B 208 that receives the samples of the configurable number of frames from the different video streams 10 and may analyze the different samples of video to ensure that no tampering occurred with a current video stream 10.

For example, classification model B 208 may be a deep learning neural network that receives ten video frames to review from different video streams 10 received from a same location. The ten video frames may be taken around the same time of day from different days (e.g., the current time, yesterday, and last week). The classification model B 208 may analyze the different samples to ensure that the delta among the different video samples is not significant. For example, a difference between two video frames may be computed by computing cosine similarity of the video frame embeddings. For instance, if the distance is greater than a configured number between 0 and 1, the frames are different, and if the distance is less than a configured number between 0 and 1, the frames are the same. If the delta is significant (e.g., the frames are different), the classification model B 208 may output a tampering classification 20 that tampering occurred to the video streams 10. If the delta is not significant (e.g., the frames are the same), the classification model B 208 may output a tampering classification 20 that no tampering occurred to the video streams 10.

Rule C 210 may focus on sensor signals. Rule C 210 may have a classification model C 212 that receives the sensor signals from the device information 12 for the camera 104 and may analyze the different sensor signals to ensure that no tampering occurred with the video streams 10.

For example, the classification model C 212 may be a deep reinforcement model that receives the sensor signals from today and previous days. The sensors may detect objects nearby and/or may detect motion nearby the camera 104 (FIG. 1). In addition, the sensors may detect whether the camera (104) moved positions. The classification model C 212 may compare sensor signals from today with sensor signals from a previous day and use the information to determine whether tampering occurred. If the sensor signals indicate that motion occurred to the camera 104 and/or nearby the camera, the classification model C 212 may output a tampering classification 20 that tampering occurred to the video streams 10. If the sensor signals indicated that no motion occurred to the camera 104 and/or nearby the camera 104, the classification model C 212 may output a tampering classification 20 that no tampering occurred to the video streams 10.

Rule D 214 may focus on device metadata. Rule D 214 may have a classification model D 216 that receives the device metadata from the device information 12 for the camera 104 and may analyze the device metadata to ensure that no tampering occurred with the video streams 10.

For example, the classification model D 216 may be a deep learning neural network that receives the device metadata and may analyze the device metadata to determine whether the device went offline. For example, the device metadata may be a heartbeat signal from the camera 104 indicating that the camera 104 is connected to the edge device 102 and/or the cloud 108 (FIG. 1). If the camera 104 is disconnected from the network and/or powered down, the heartbeat signal may be lost. The classification model D 216 may analyze the heartbeat signal for the camera 104 to determine whether any disruptions occurred to the heartbeat signal. If a disruption occurred to the heartbeat signal (e.g., the signal went offline and is back), the classification model D 216 may output a tampering classification 20 that tampering occurred to the video streams 10. If no disruptions occurred to the heartbeat signal (e.g., remained online), the classification model D 216 may output a tampering classification 20 that no tampering occurred to the video streams 10.

As such, each rule (Rule A 202, Rule B 206, Rule C 210, Rule D 214) may try to identify a different scenario of tampering. In addition, the different classification models (classification model A 204, classification model B 206, classification model C 210, classification model D 214) may output the same tampering classifications 20 for the video streams 10 and/or may output different tampering classifications 20 for the video streams 10.

In some implementations, a user interface (UI) may list the different rules available (e.g., Rule A 202, Rule B 206, Rule C 210, Rule D 214) for use in determining whether tampering occurred on the video streams 10. For example, the UI may be on a website. The rules 16 may be populated by default based on the business type or the monitored environment. The tampering detection firewall 14 may run all available rules by default. In addition, a user, such as an administrator, may enable or disable different rules used by the tampering detection firewall 14. The user may add more rules 16 to the default settings, remove rules 16 from the default settings, and/or update the classification models 18. In addition, the user may design or build custom rules 16 or classification models 18 using the UI. The user may use the UI to select whether to run all rules or select a subset of the rules to run. For example, the user may select a subset of rules that have lower compute cost to run first (e.g., requires a lower number of cores to perform the rule relative to a higher number of cores needed to perform a different rule). Another example may include the user selecting a number of rules 16 to include in the subset of rules based on the monitoring environment. If tampering is found using the subset of rules, the user may select to end the processing and not run the more computational expensive rules that take more power and/or more computational cycles to run.

If any of the tampering classifications 20 output from the different classification models (classification model A 204, classification model B 206, classification model C 210, classification model D 214) indicate that tampering occurred, the tampering detection firewall 14 may send an alert 22 indicating that tampering occurred to the video streams 10. The alert 22 may be received by users of the video analytic systems to perform one or more actions in response to the tampering.

As such, tampering detection firewall 14 may be used to ensure that the videos received at the edge device 102 and/or analyzed by the video analytics component 24 are genuine without any tampering.

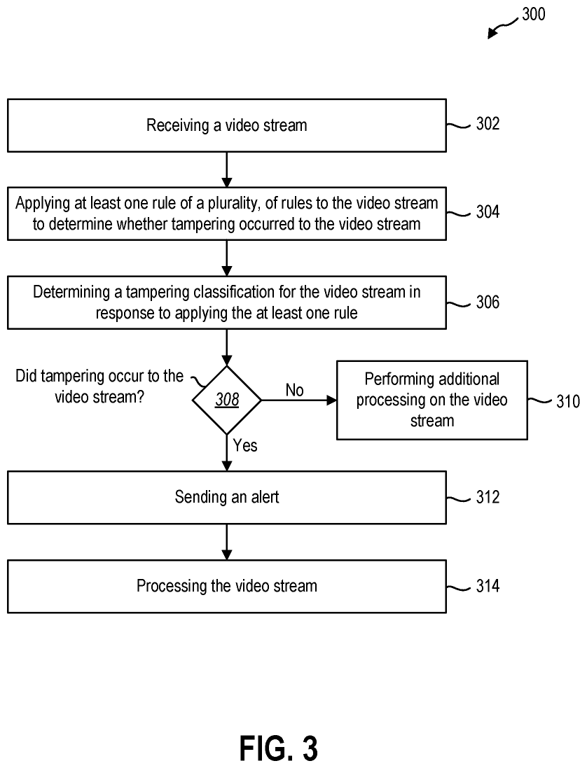

Referring now to FIG. 3, illustrated is an example method 300 performed by the tampering detection firewall 14 (FIG. 1) of the edge device 102 (FIG. 1) for determining whether tampering occurred to video streams 10 (FIG. 1) and/or device information 12 (FIG. 1). The actions of method 300 may be discussed below with reference to the architecture of FIG. 1.

At 302, method 300 may include receiving a video stream. The tampering detection firewall 14 may receive a plurality of video streams 10 from one or more cameras 104 (FIG. 1) in communication with the edge device 102. In addition, the tampering firewall 14 may receive a plurality of device information 12 from one or more devices 106 in communication with the edge device 102 and/or the cameras 104.

At 304, method 300 may include applying at least one rule of a plurality of rules to the video stream to determine whether tampering occurred to the video stream. Tampering may include, for example, modifying device information 12, modifying the video streams 10, and/or modifying network information to trick the systems and processes on the edge device 102 and/or the cloud 108 into thinking the video streams 10 and/or the device information 12 are genuine. The tampering detection firewall 14 may have a set of rules 16 to identify whether different types of tampering occurred. The tampering detection firewall 14 applies one or more of the rules 16 to determine whether any tampering occurred on the video streams 10 and/or the device information 12. The tampering detection firewall 14 may run all the rules 16 to determine whether any tampering occurred. In addition, the tampering detection firewall 14 may select a subset of the rules 16 to run based on one or more conditions. The one or more conditions may include, but are not limited to, a business type, an environment being monitored, default settings, user selected settings, custom models, similar customers, compute costs of the rules, and/or energy consumption of the rules. The subset of rules 16 may be a default setting and/or automatically selected by the tampering detection firewall 14. In addition, the subset of rules 16 may be selected by a user of the system using, for example, a website or an extensible markup language (XML) configuration. The users may select which rules 16 to include in the subset of rules. In an implementation, the tampering detection firewall rules 16 may be configured by users (e.g., an administrator) on a website. The rules 16 may be populated by default based on the business type or the monitored environment. The users of the system may add more rules 16 to the default settings, remove rules 16 from the default settings, and/or update the classification models 18 of the default settings and give the Uniform Resource Locator (URL)/application programming interface (API)/method endpoint that can evaluate the video frames. The users may also select different rules 16 to include in the subset of rules than the default rules. Moreover, the users may build custom rules 16 and/or classification models 18 for evaluating the frames of the video streams 10 for tampering.

One example use case may include selecting the subset of rules based on the business type. For example, the users may select to add more rules 16 to the subset of rules for a high security environment relative to the number of rules 16 selected for the subset of rules for a lower security environment or a different monitoring environment. Another use case may include selecting the subset of rules based on a similar customer. The tampering detection firewall 14 may use collaborative filtering algorithms for similarity to pre-populate the default rules 16. For example, the customer may be a bank and the tampering detection firewall 14 may automatically select a subset of rules based on similar rules a different bank customer uses for determining whether any tampering occurred to the video streams. Another example use case may including selecting specific rules 16 to run based on the monitored environment. For example, the environment may be a shipping port and the tampering detection firewall 14 may automatically select the subset of rules 16 predefined for a shipping port.

One example of tampering with the video streams 10 may include playing another recording of the video, such as, a recording from yesterday. Another example of tampering with the video streams 10 may include taking the last two hours of the video stream and generating a new video stream from the last two hours and pointing to the new video stream. Any number of scenarios may occur for tampering with the video streams 10.

Each rule 16 may focus on one or more features of tampering. As such, one rule 16 may focus on a single feature of tampering, while another rule 16 may focus on a combination of features of tampering. A first example rule may identify whether the network route changed or is modified. A second example rule may identify whether a deep fake video is shown. A third example rule may identify whether a video stream of a previous day or past month is shown.

Each rule 16 may run a different classification model 18 that generates a tampering classification 20 to classify whether tampering occurred on the video streams 10 and/or the device information 12. The tampering detection firewall 14 may run different classification models 18 for each rule 16 to determine whether tampering occurred on the video streams 10 and/or the device information 12. The classification models 18 may include different machine learning models or a combination of machine learning models. As such, one rule 16 may map to one classification model 18. Moreover, different rules 16 may have different compute costs and/or energy consumption of the edge device 102.

In some implementations, the classification model 18 is a deep learning neural network model that receives the features of the video stream as input and outputs a tampering classification 20 of the video stream 10 as tampered or not tampered. In some implementations, the classification model 18 is a deep reinforcement model. In some implementations, the classification model 18 is a combination of Convolution Neural Networks and Bi-Directional Neural Networks. In some implementations, the classification model 18 is a simplistic Logistic Regression model.

Different combination of machine learning may be used for the classification models 18. For example, a logistic regression model may be used for an initial classification of the video streams 10 and/or the device information 12 while a deep neural network may be used to perform a fine grain analysis of the features of the video streams 10.

In some implementations, a retraining of the classification models 18 may occur. Each edge device 102 sends information back to the cloud 108. Information may include, but is not limited to, video streams 10, device information 12, network latency information, ping trace routes information, and/or runtime information. A portion of the video stream data may be sent to the cloud 108 for retraining the classification models 18. Retraining may occur on the cloud 108 with the most recent data. For example, daily video samples may be sent to the cloud 108 to update and/or train the classification models 18.

The cloud 108 may have a training component 26 that may use the information to train an updated classification model 28. The updated classification model 28 may be a new classification model or an augmented classification model. By aggregating the information from different edge devices 102, the training component 26 may learn from different edge devices 102 to build a more robust classification model.

The cloud 108 may deploy or send the updated classification models 28 to the edge devices 102. The updated classification models 28 may replace existing classification models 18 on the edge device 102. In addition, the updated classification models 28 may be used as a new classification model 18 with a new rule 16 on the edge device 102. As such, adaptive training strategies may ensure that the classification models 18 are continuously trained and/or updated using the recent data from the captured video.

At 306, method 300 may include determining a tampering classification for the video stream in response to applying the at least one rule to the video stream. The tampering detection firewall 14 may determine the tampering detection classification 20 based on the output of one or more classification models 18 in response to applying the one or more rules 16 to the video streams 10. The different classification models 18 may provide the same tampering classification output for the video streams 10. In addition, the different classification models 18 may provide different tampering classifications output for the video streams 10. As such, the tampering detection firewall 14 may aggregate the outputs from the different classification models 18 to determine the tampering classification 20 for the video streams 10. For example, if one classification model 18 outputs that tampering occurred to the video streams 10 and three classification models 18 output that no tampering occurred to the video streams 10, the tampering detection firewall 14 may determine that tampering occurred to the video streams 10 based on the output of all of the classification models 18.

At 308, method 300 may include determining whether tampering occurred to the video stream. The tampering detection firewall 14 may use the tampering classification 20 in determining whether any tampering occurred to the video stream 10. For example, the tampering classification 20 may indicate that tampering occurred to the video stream 10. The tampering classification 20 may indicate that no tampering occurred to the video stream 10.

At 310, method 300 may include performing additional processing on the video stream in response to determining that no tampering occurred on the video stream. If the tampering classification 20 identifies that no tampering occurred to the device information 12 and/or the video streams 10, the edge device 102 may perform additional processing on the video streams 10. Additional processing may include, but is not limited to, archiving the video streams 10, performing video analytics on the video streams 10, and/or merging the video streams 10 with other sensors. For example, the tampering detection firewall 14 may send the video streams 10 to a video analytics component 24. The video analytics component 24 may perform video analytics by analyzing the images in the video streams 10 and performing one or more actions in response to the analysis. Examples of video analytics may include, but is not limited to, video surveillance, monitoring activities, monitoring movements, and/or monitoring compliance with rules or regulations. In an implementation, the video analytics component 24 may be remote from the edge device 102 on the cloud 108. As such, the tampering detection firewall 14 may send the video streams 10 and/or the device information 12 to the cloud 108 for analysis.

At 312, method 300 may include sending an alert in response to the determining that tampering occurred on the video stream. If the tampering classification 20 identifies that tampering occurred to the device information 12 and/or the video streams 10, the tampering detection firewall 14 may generate an alert 22 notifying users of system 100 that the tampering occurred. The alert 22 may include, for example, automatically sending a message (e.g., sending an e-mail or a SMS message to a monitoring group), automatically placing a call (e.g., automatically calling a monitoring group, security, or law enforcement individuals), and/or sounding an alarm. The users may take one or more actions in response to receiving the alert 22 indicating that tampering occurred. Example actions may include, but are not limited to, sending an email message, sending a text message, sending a video alert, sending an audible alert, triggering an alarm, redirecting the camera 104, fixing the camera 104, fixing the device 106, and/or calling law enforcement individuals (e.g., calling 911).

At 314, method 300 may include processing the video stream in response to in response to the determining that tampering occurred on the video stream. Processing may include filtering or removing the video streams 10 and/or the device information 12. For example, the tampering detection firewall 14 may prevent the video streams 10 and/or the device information 12 from use by the video analytics component 24. Thus, the tampering detection firewall 14 may filter out any suspicious video streams 10 and/or the device information 12.

Processing may also include sending the video stream or a portion of the video stream data to a training component 26 to use the information from the video stream to train or retrain the classification models 18. For example, the edge devices 102 may send a portion of the video frames with significant information and/or important information, such as, cars, objects, individuals, animals, etc. to the cloud 108 to conserve the network bandwidth used for transmitting the video frames. Retraining may occur on the cloud 108 with the most recent data. In an implementation, retraining may occur on the edge device 102.

The cloud 108 may deploy or send the updated classification models 28 to the edge devices 102. The updated classification models 28 may replace existing classification models 18 on the edge device 102. In addition, the updated classification models 28 may be used as a new classification model 18 with a new rule 16 on the edge device 102. As such, adaptive training strategies may ensure that the classification models 18 are continuously trained and/or updated using the recent data from the captured video.

One example use case may include a bank having a video system monitoring the ATM devices. The tampering detection firewall 14 may receive the video streams 10 from the ATM devices and may apply one or more rules 16 to analyze the video streams 10 for similar characteristics. At one ATM device, an attacker may have changed the video stream of the ATM to the previous day. The classification models 18 of the rules 16 may identify similarities in the video streams 10 from today with the video streams 10 received yesterday and may generate a tampering classification 20 indicating that tampering occurred to the video streams 10. The tampering detection firewall 14 may send an alert identifying that tampering occurred with the ATM video. A user of the video system may fix the video received from the ATM device in response to receiving the alert. Thus, instead of the video system thinking everything is fine at the ATM when the video of the previous day is playing, the video system may be fixed to show the accurate video feed at the ATM device in response to receiving the alert.

As such, method 300 may be used to identify at the edge whether any tampering occurred with the video streams 10 received at the edge device 102. By identifying any tampering, security may be improved at the edge device 102 by ensuring that the information received by the edge device 102 is accurate and/or authentic. In addition, the tampering detection firewall 14 may provide security to the video analytic component 24 by ensuring that the video analytic component 24 uses authentic or genuine video streams 10 and/or device information 12 in performing the video analytics.

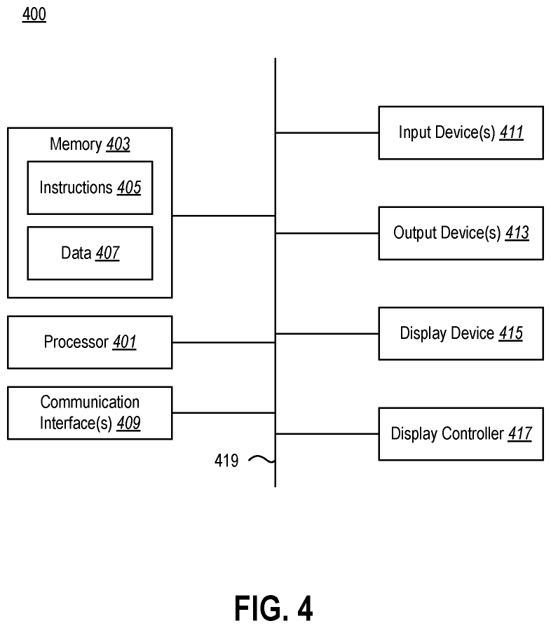

FIG. 4 illustrates certain components that may be included within a computer system 400. One or more computer systems 400 may be used to implement the various devices, components, and systems described herein.

The computer system 400 includes a processor 401. The processor 401 may be a general-purpose single or multi-chip microprocessor (e.g., an Advanced RISC (Reduced Instruction Set Computer) Machine (ARM)), a special purpose microprocessor (e.g., a digital signal processor (DSP)), a microcontroller, a programmable gate array, etc. The processor 401 may be referred to as a central processing unit (CPU). Although just a single processor 401 is shown in the computer system 400 of FIG. 4, in an alternative configuration, a combination of processors (e.g., an ARM and DSP) could be used.

The computer system 400 also includes memory 403 in electronic communication with the processor 401. The memory 403 may be any electronic component capable of storing electronic information. For example, the memory 403 may be embodied as random access memory (RAM), read-only memory (ROM), magnetic disk storage mediums, optical storage mediums, flash memory devices in RAM, on-board memory included with the processor, erasable programmable read-only memory (EPROM), electrically erasable programmable read-only memory (EEPROM) memory, registers, and so forth, including combinations thereof.

Instructions 405 and data 407 may be stored in the memory 403. The instructions 405 may be executable by the processor 401 to implement some or all of the functionality disclosed herein. Executing the instructions 405 may involve the use of the data 407 that is stored in the memory 403. Any of the various examples of modules and components described herein may be implemented, partially or wholly, as instructions 405 stored in memory 403 and executed by the processor 401. Any of the various examples of data described herein may be among the data 407 that is stored in memory 403 and used during execution of the instructions 405 by the processor 401.

A computer system 400 may also include one or more communication interfaces 409 for communicating with other electronic devices. The communication interface(s) 409 may be based on wired communication technology, wireless communication technology, or both. Some examples of communication interfaces 409 include a Universal Serial Bus (USB), an Ethernet adapter, a wireless adapter that operates in accordance with an Institute of Electrical and Electronics Engineers (IEEE) 802.11 wireless communication protocol, a Bluetooth® wireless communication adapter, and an infrared (IR) communication port.

A computer system 400 may also include one or more input devices 411 and one or more output devices 413. Some examples of input devices 411 include a keyboard, mouse, microphone, remote control device, button, joystick, trackball, touchpad, and lightpen. Some examples of output devices 413 include a speaker and a printer. One specific type of output device that is typically included in a computer system 400 is a display device 415. Display devices 415 used with embodiments disclosed herein may utilize any suitable image projection technology, such as liquid crystal display (LCD), light-emitting diode (LED), gas plasma, electroluminescence, or the like. A display controller 417 may also be provided, for converting data 407 stored in the memory 403 into text, graphics, and/or moving images (as appropriate) shown on the display device 415.

The various components of the computer system 400 may be coupled together by one or more buses, which may include a power bus, a control signal bus, a status signal bus, a data bus, etc. For the sake of clarity, the various buses are illustrated in FIG. 4 as a bus system 419.

The techniques described herein may be implemented in hardware, software, firmware, or any combination thereof, unless specifically described as being implemented in a specific manner. Any features described as modules, components, or the like may also be implemented together in an integrated logic device or separately as discrete but interoperable logic devices. If implemented in software, the techniques may be realized at least in part by a non-transitory processor-readable storage medium comprising instructions that, when executed by at least one processor, perform one or more of the methods described herein. The instructions may be organized into routines, programs, objects, components, data structures, etc., which may perform particular tasks and/or implement particular data types, and which may be combined or distributed as desired in various embodiments.

Computer-readable mediums may be any available media that can be accessed by a general purpose or special purpose computer system. Computer-readable mediums that store computer-executable instructions are non-transitory computer-readable storage media (devices). Computer-readable mediums that carry computer-executable instructions are transmission media. Thus, by way of example, and not limitation, embodiments of the disclosure can comprise at least two distinctly different kinds of computer-readable mediums: non-transitory computer-readable storage media (devices) and transmission media.

As used herein, non-transitory computer-readable storage mediums (devices) may include RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

The steps and/or actions of the methods described herein may be interchanged with one another without departing from the scope of the claims. In other words, unless a specific order of steps or actions is required for proper operation of the method that is being described, the order and/or use of specific steps and/or actions may be modified without departing from the scope of the claims.

The term “determining” encompasses a wide variety of actions and, therefore, “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing and the like.

The articles “a,” “an,” and “the” are intended to mean that there are one or more of the elements in the preceding descriptions. The terms “comprising,” “including,” and “having” are intended to be inclusive and mean that there may be additional elements other than the listed elements. Additionally, it should be understood that references to “one implementation” or “an implementation” of the present disclosure are not intended to be interpreted as excluding the existence of additional implementations that also incorporate the recited features. For example, any element described in relation to an implementation herein may be combinable with any element of any other implementation described herein. Numbers, percentages, ratios, or other values stated herein are intended to include that value, and also other values that are “about” or “approximately” the stated value, as would be appreciated by one of ordinary skill in the art encompassed by implementations of the present disclosure. A stated value should therefore be interpreted broadly enough to encompass values that are at least close enough to the stated value to perform a desired function or achieve a desired result. The stated values include at least the variation to be expected in a suitable manufacturing or production process, and may include values that are within 5%, within 1%, within 0.1%, or within 0.01% of a stated value.

A person having ordinary skill in the art should realize in view of the present disclosure that equivalent constructions do not depart from the spirit and scope of the present disclosure, and that various changes, substitutions, and alterations may be made to implementations disclosed herein without departing from the spirit and scope of the present disclosure. Equivalent constructions, including functional “means-plus-function” clauses are intended to cover the structures described herein as performing the recited function, including both structural equivalents that operate in the same manner, and equivalent structures that provide the same function. It is the express intention of the applicant not to invoke means-plus-function or other functional claiming for any claim except for those in which the words ‘means for’ appear together with an associated function. Each addition, deletion, and modification to the implementations that falls within the meaning and scope of the claims is to be embraced by the claims.

The present disclosure may be embodied in other specific forms without departing from its spirit or characteristics. The described embodiments are to be considered as illustrative and not restrictive. The scope of the disclosure is, therefore, indicated by the appended claims rather than by the foregoing description. Changes that come within the meaning and range of equivalency of the claims are to be embraced within their scope.

What is claimed is:

1. A method performed by an edge device, comprising:
receiving a video stream;
applying, at the edge device, at least one rule of a plurality of rules to the video stream to determine whether tampering occurred to the video stream, wherein each rule of the plurality of rules includes a corresponding classification model running a machine learning algorithm that analyzes the video stream and outputs a tampering classification for the video stream;
determining the tampering classification for the video stream that identifies whether any tampering occurred to the video stream in response to applying the at least one rule to the video stream;
sending an alert in response to the tampering classification indicating that tampering occurred to the video stream; and
processing the video stream in response to the tampering classification indicating that tampering occurred to the video stream.

2. The method of claim 1, wherein tampering includes one or more of modifying the video stream, modifying network settings, or modifying device information.

3. The method of claim 2, wherein modifying the video stream includes at least one of pointing to a different video recording, simulating a video, changing a route of the video stream, or directing a camera to another location.

4. The method of claim 1, further comprising:
selecting a subset of rules of the plurality of rules to apply to the video stream based on one or more conditions, wherein each rule of the subset of rules focuses on a different scenario of tampering; and
applying each rule of the subset of rules to the video stream.

5. The method of claim 1, wherein the classification model is one of a deep learning neural network, a deep reinforcement model, a combination of Convolution Neural Networks and Bi-Directional Neural Networks, a simplistic logistic regression model, or any combination thereof.

6. The method of claim 1, wherein processing the video stream further comprises:
retraining the classification model by using recent data from the video stream and information relating to the video stream to update the machine learning algorithm.

7. The method of claim 1, further comprising:
receiving device information including one or more of sensor information, network latency information, ping trace route information, runtime information, or heartbeat information, and
wherein the classification model uses the device information in determining whether the tampering occurred to the video stream.

8. The method of claim 1, further comprising:
performing additional processing on the video stream in response to the tampering classification indicating that no tampering occurred to the video stream, wherein the additional processing includes one or more of video analytics, archiving, or merging the video stream with other sensors.

9. An edge device, comprising:
one or more processors;
memory in electronic communication with the one or more processors; and
instructions stored in the memory, the instructions executable by the one or more processors to:
receive a video stream from a camera in communication with the edge device;
apply at least one rule of a plurality of rules to the video stream to determine whether tampering occurred to the video stream, wherein each rule of the plurality of rules includes a corresponding classification model running a machine learning algorithm that analyzes the video stream and outputs a tampering classification for the video stream;
determine the tampering classification for the video stream that identifies whether any tampering occurred to the video stream in response to applying the at least one rule to the video stream;
send an alert in response to the tampering classification indicating that tampering occurred to the video stream; and
process the video stream in response to the tampering classification indicating that tampering occurred to the video stream.

10. The edge device of claim 9, wherein tampering includes one or more of modifying the video stream, modifying network settings, or modifying device information.

11. The edge device of claim 10, wherein modifying the video stream includes at least one of pointing to a different video recording, simulating a video, changing a route of the video stream, or directing a camera to another location.

12. The edge device of claim 9, wherein the instructions are further executable by the one or more processors to:
select a subset of rules of the plurality of rules to apply to the video stream based on one or more conditions, wherein each rule of the subset of rules focuses on a different scenario of tampering; and
apply each rule of the subset of rules to the video stream.

13. The edge device of claim 9, wherein the classification model is one of a deep learning neural network, a deep reinforcement model, a combination of Convolution Neural Networks and Bi-Directional Neural Networks, a simplistic logistic regression model, or any combination thereof.

14. The edge device of claim 9, wherein the instructions are further executable by the one or more processors to process the video stream by retraining the classification model by using recent data from the video stream and information relating to the video stream to update the machine learning algorithm.

15. The edge device of claim 9, wherein the instructions are further executable by the one or more processors to:
receive device information, and wherein the classification model uses the device information in determining whether the tampering occurred to the video stream.

16. A method, comprising:
receiving, at an edge device, device information from a plurality of devices in communication with the edge device.
applying, at the edge device, at least one rule of a plurality of rules to the device information to determine whether tampering occurred to the device information, wherein each rule of the plurality of rules includes a corresponding classification model running a machine learning algorithm that analyzes the device information and outputs a tampering classification for the device information;
determining the tampering classification for the device information that identifies whether any tampering occurred to the device information in response to applying the at least one rule to the device information; and
sending an alert in response to the tampering classification indicating that tampering occurred to the device information.

17. The method of claim 16, wherein the plurality of devices are internet of things (IoT) devices.

18. The method of claim 16, wherein the device information includes one or more of a heartbeat of the device or sensor information.

19. The method of claim 16, wherein the classification model is one of a deep learning neural network, a deep reinforcement model, a combination of Convolution Neural Networks and Bi-Directional Neural Networks, a simplistic logistic regression model, or any combination thereof.

20. The method of claim 16, further comprising:
retraining the classification model by using recent data from the device information to update the machine learning algorithm.
